(19) United States
(12) Patent Application Publication
(10) Pub. No.: US 2022/0026326 A1
(43) Pub. Date: Jan. 27, 2022

(54) A Multiaxial Creep-Fatigue Prediction Method Based On ABAQUS

(71) Applicant: East China University of Science And Technology, Shanghai (CN)

(72) Inventors: Runzi Wang, Shanghai (CN); Xiancheng Zhang, Shanghai (CN); Sujuan Guo, Shanghai (CN); Guangjian Yuan, Shanghai (CN); Xumin Zhu, Shanghai (CN); Shantung Tu, Shanghai (CN)

(21) Appl. No.: 17/421,929

(22) PCT Filed: Oct. 31, 2019
(86) PCT No.: PCT/CN2019/114718

§ 371 Date: Jul. 9, 2021

(30) Foreign Application Priority Data
Jan. 11, 2019 (CN) 201910026871.3

(51) Int. Cl. G01N 3/08; G06N 5/02

(52) U.S. Cl. CPC G01N 3/08; G01N 2203/0073; G01N 2203/0071; G06N 5/02

(57) ABSTRACT

The present invention discloses a multiaxial creep-fatigue prediction method based on ABAQUS, which comprises: S1: establishing an ABAQUS finite element model, and defining the viscoplastic constitutive equation of the material to be tested by means of the user subroutine UMAT; S2: determining the model parameters required by the viscoplastic constitutive equation; S3: establishing the fatigue damage calculation model and creep damage calculation model of the multiaxial stress-strain state of the material to be tested; S4: establishing an ABAQUS finite element model under the multiaxial stress-strain state, and calculating the stress-strain tensor of each cycle based on the defined viscoplastic constitutive equation and the model parameters; S5: calculating the equivalent stress and equivalent plastic strain by means of the user subroutine USDFLD, and superimposing the fatigue damage and creep damage of each cycle according to the linear cumulative damage criterion to obtain the crack initiation life of the material to be tested based on the fatigue damage calculation model and creep damage calculation model in combination with the stress-strain tensor.

### CROSS-REFERENCE TO RELATED APPLICATIONS

This application is a national application of PCT/CN2019/114718, filed on Oct. 31, 2019 and claims the priority of it. The contents of PCT/CN2019/114718 are all hereby incorporated by reference.

### BACKGROUND OF THE INVENTION

### 1. Field of the Invention

The present invention relates to the field of numerical simulation, in particular to a multiaxial creep-fatigue prediction method.

### 2. Related Art

With the increasing demand for large-scale, high-performance, and long-life performance of high-temperature rotating parts, the structural integrity assessment of structures containing geometric discontinuities in complex and harsh environments has become one of the key technical bottlenecks that need to be resolved. The multiaxial stress-strain state caused by geometric discontinuities and complex loading history inevitably limit the service life of such parts. In recent years, the development of finite element software can satisfy people's understanding of complex stress-strain behavior and provides the feasibility of accurate life prediction in this state.

Nowadays, the creep-fatigue analysis and life prediction for complex structures can be divided into three types. The first is the finite element theory of crystal plasticity based on microscopic analysis methods in recent years, which characterizes the creep-fatigue evolution process by means of fatigue indicator factors such as accumulated plastic slip band and stored energy dissipation. The second is the theory of continuous damage mechanics that can describe the stages of crack initiation and propagation, which introduces a unified creep-fatigue constitutive model through damage variables to describe the process of damage accumulation to fracture of materials under cyclic loading. The third is popular in the current design criteria, which describes the creep-fatigue behavior through a non-unified constitutive model, and predicts the creep life through the separately calculated creep damage and fatigue damage equations and the phenomenological envelope. However, the three methods have their own shortcomings: the first method is only suitable for describing the stress-strain behavior at the micro level, and is not applicable to large high-temperature parts at the macro level; the second method focuses on describing the creep-fatigue behavior in the stage of crack propagation, and the programming complexity, poor convergence and high computational cost determine that it does not have strong universal applicability. Although the third method has the characteristics of strong operability, it is mostly used to analyze the uniaxial stress-strain behavior under the steady state and is not accurate for creep-fatigue analysis and prediction under complex stress-strain state and complex loading history.

Based on this, it is expected to obtain a new creep-fatigue prediction method which has strong practicability, to better realize the creep-fatigue analysis of geometric discontinuous structures under multiaxial stress-strain state, and obtain more intuitive and accurate results.

### SUMMARY OF THE INVENTION

The purpose of the present invention is to provide a multiaxial creep-fatigue prediction method based on ABAQUS, which can better realize the creep-fatigue analysis of geometric discontinuous structures under multiaxial stress-strain state, and obtain more intuitive and accurate results. In addition, the creep-fatigue prediction method has strong practicability.

According to the above mentioned purpose of the invention, the present invention proposes a multiaxial creep-fatigue prediction method based on ABAQUS, which comprises steps:

S1: establishing an ABAQUS finite element model, and defining the viscoplastic constitutive equation of the material to be tested in the process of cycling loads by means of the user subroutine UMAT;

S2: determining the model parameters required by the viscoplastic constitutive equation;

S3: establishing the fatigue damage calculation model and creep damage calculation model of the multiaxial stress-strain state of the material to be tested;

S4: establishing an ABAQUS finite element model under the multiaxial stress-strain state, and calculating the stress-strain tensor of each cycle based on the viscoplastic constitutive equation defined by the user subroutine UMAT in S1 and the model parameters in S2;

S5: calculating the equivalent stress and equivalent plastic strain by means of the user subroutine USDFLD, and superimposing the fatigue damage and creep damage of each cycle according to the linear cumulative damage criterion to obtain the crack initiation life of the material to be tested based on the fatigue damage calculation model and creep damage calculation model in S3 in combination with the stress-strain tensor obtained in S4.

In the multiaxial creep-fatigue prediction method based on ABAQUS of the present invention, the user subroutine UMAT in S4 can calculate the stress-strain tensor of each node. The functions of the user subroutine USDFLD set in S5 are as follows: (1) extracting the stress-strain tensor of S4 and performing a scalar calculation to calculate the equivalent stress-strain value; (2) inputting the fatigue damage calculation model and the creep damage calculation model of S3 into the user subroutine USDFLD to obtain the fatigue damage and creep damage of each cycle; the calculation of the above mentioned damage can be based on the equivalent stress-strain; (3) superimposing the damage of each cycle by performing the linear cumulative damage to obtain the crack initiation life.

Further, in the multiaxial creep-fatigue prediction method based on ABAQUS of the present invention, in S2, the material to be tested is subjected to a uniaxial tensile test at a given temperature and uniaxial creep-fatigue tests with different strain amplitudes and holding time at the given temperature, such that the high-temperature tensile curve, the cyclic softening curve, the stress relaxation curve and the hysteresis loop are obtained to determine the model parameters required by the viscoplastic constitutive equation.

Further, in the multiaxial creep-fatigue prediction method based on ABAQUS of the present invention, in S2, the high-temperature tensile curve, the cyclic softening curve, the stress relaxation curve and the hysteresis loop of the ABAQUS finite element model are simulated by trial parameter method, making them consistent with the experimental results. That is to say, the curves obtained by the trial parameter method have a good degree of fitting with the curves obtained by the experiment such that the model parameters required by the viscoplastic constitutive equation are obtained.

Further, in the multiaxial creep-fatigue prediction method based on ABAQUS of the present invention, in S1, the viscoplastic constitutive equation comprises: the master equation of the viscoplastic constitution, the viscoplastic equation of the viscoplastic constitution, the inelastic follow-up strengthening equation for the back stress tensor of the viscoplastic constitution and the isotropic strengthening equation of the viscoplastic constitution.

Further, in the multiaxial creep-fatigue prediction method based on ABAQUS of the present invention, S1 also comprises: S11: describing the master equation of the viscoplastic constitution by using the following formula (1) and formula (2):

$$\begin{matrix}{ɛ}_{t} = {ɛ}_{e} + {ɛ}_{in} ; & ( 1 ) \\ {ɛ}_{e} = \frac{1 + v}{E} σ - \frac{v}{E} ( tr σ ) I ; & ( 2 )\end{matrix}$$

In the formulas, εₜ is the total strain tensor, and εₑ is the elastic strain tensor, and εᵢₙ is the inelastic strain tensor, and E is the elastic modulus, and ν is the Poisson's ratio, and σ is the stress tensor, and trσ is the track of the stress tensor, and I is the second-order unit tensor.

S12: describing the viscoplastic equation of the viscoplastic constitution by using the following formula (3), formula (4) and formula (5):

$$\begin{matrix}{\dot{ɛ}}_{in} = \frac{3}{2} \dot{p} \frac{s - a}{J ( σ - α )} ; & ( 3 ) \\ \dot{p} = \sqrt{\frac{2}{3} {\dot{ɛ}}_{in} \text{:} {\dot{ɛ}}_{in}} = {( \frac{J ( σ - α ) - R - κ}{K} )}^{n} ; & ( 4 ) \\ J ( σ - a ) = \sqrt{\frac{3}{2} ( s - a ) \text{:} ( s - a )} ; & ( 5 )\end{matrix}$$

In the formulas, \dot{ε}ᵢₙ is the inelastic strain rate tensor, and p̅ is the cumulative inelastic strain rate, and s is the deflection of the stress tensor, and a is the deflection of the back stress tensor, and J(σ−α) is the Von-Mises stress space distance, and α is the back stress tensor, and K and n are rate-related material parameters, and R is the isotropic deformation resistance, and κ is the initial size of the elastic region, and “:” represents the inner product of the tensor.

S13: describing the inelastic follow-up strengthening equation for the back stress tensor of the viscoplastic constitution by using the following formula (6) and formula (7):

α̅ᵢ=ζᵢ(⅔rᵢε̅ᵢₙ−αᵢp̅)−γ[J(αᵢ)]^{m(q)}αᵢ (6);

m(q)=ϕ₁e^{-q/ω}+ϕ₂ (7);

In the formulas, αᵢ represents each part of several back stress tensor parts, and ζᵢ and rᵢ are the material parameters of each part of the back stress tensor, and γ is the material parameter describing the static recovery term, and m(q) is the exponential equation describing the static recovery term, and q is the plastic strain amplitude, and ϕ₁, ϕ₂ and ω are the three material parameters in the exponential equation, and J(αᵢ) represents the second invariant of the back stress, and e represents the exponential function based on the natural constant, and \dot{α}ᵢ represents the stress change rate of each part of the back stress tensor.

S14: describing the isotropic strengthening equation of the viscoplastic constitution by using the following formula (8):

\dot{R}=b(Q−R)\dot{p}+H(1+bp)\dot{p} (8);

In the formula, Q is the asymptotic value of the isotropic resistance softening rapidly in the first stage, and b is the speed parameter close to the asymptotic value, and H is the slope-related parameter of linear softening in the second stage, and p is the cumulative inelastic strain, and \dot{R} represents the isotropic enhancement rate.

Further, in the multiaxial creep-fatigue prediction method based on ABAQUS of the present invention, the back stress tensor is divided into 8 parts, namely, α=Σᵢ₌₁⁸αᵢ.

Further, in the multiaxial creep-fatigue prediction method based on ABAQUS of the present invention, in S3, the fatigue damage calculation model of the multiaxial stress-strain state is:

$${( \frac{{τ}_{max}}{{τ}_{f}^{′}} \frac{Δ γ}{2} + \frac{{σ}_{n , max}}{{σ}_{f}^{′}} \frac{{Δɛ}_{n}}{2} )}_{max} = \frac{{τ}_{f}^{′}}{G} {( \frac{2}{{d}_{f}} )}^{2 {b}_{0}} + {{γ}_{f}^{′} ( \frac{2}{{d}_{f}} )}^{2 {c}_{0}} ; \qquad ( 9 )$$

In the formula, “( )ₘₐₓ” represents the maximum fatigue damage factor on the critical plane, and τₘₐₓ is the maximum shear stress on the critical plane, and [symbol] is the constant of shear fatigue strength, and Δγ/2 is the shear strain amplitude on the critical plane, and σ_{n,max} is the maximum normal stress on the critical plane, and [symbol] is the constant of fatigue strength, and Δεₙ/2 is the normal strain amplitude on the critical plane, and G is the shear modulus, and d_{f} is the fatigue damage of one cycle, and b₀ is the index of fatigue strength, and [symbol] is the constant of shear fatigue ductility, and c₀ is the index of fatigue ductility.

The creep damage calculation model of the multiaxial stress-strain state is:

$$\{ \begin{matrix}{d}_{c} = {\int }_{0}^{{t}_{h}} \{ \frac{\frac{Z \cdot {M}_{1}}{Z + t} \frac{Z \cdot {N}_{1}}{Z + t} \cdot log ( 1 + \frac{t}{Z} )}{min [ {{φ}_{1} [ \frac{Z \cdot {M}_{1}}{Z + t} \frac{Z \cdot {N}_{1}}{Z + t} \cdot log ( 1 + \frac{t}{Z} ) ]}^{{n}_{1}} \cdot MDF , {w}_{f , trans} ]} - \\ \frac{\frac{Z \cdot {M}_{1}}{Z + t} \frac{Z \cdot {N}_{1}}{Z + t} \cdot log ( 1 + \frac{t}{Z} )}{{w}_{f , trans}} \} \\ {M}_{1} = \frac{{\overline{σ}}_{0} \cdot ( A log Δ {\overline{ɛ}}_{pp} + B )}{\overline{E} ln 10} \cdot log ( 1 + \frac{{\overline{σ}}_{m}}{{\overline{σ}}_{0}} ) \\ {N}_{1} = \frac{{( A log Δ {\overline{ɛ}}_{pp} + B )}^{2}}{\overline{E} ln 10} \\ MDF = exp [ \frac{2}{3} ( \frac{{n}_{2} - 0.5}{{n}_{2} + 0.5} ) ] / exp [ 2 ( \frac{{n}_{2} - 0.5}{{n}_{2} + 0.5} ) \frac{{σ}_{H}}{\overline{σ}} ] ;\end{matrix} \qquad ( 10 )$$

In the formula, d_{c} is the creep damage of one cycle, and tₕ is the holding time of one cycle, and Z is the elastic following factor, and t represents the time from the start of loading in one cycle, and φ₁ is the first linear regression parameter of creep damage, and MDF is the multiaxial ductility factor, and n₁ is the second linear regression parameter of creep damage, and w_{f,trans} is the plateau value of the failure strain energy density, and σ̅₀ is the maximum equivalent stress before loading in one cycle, and A is the first parameter of relaxation, and B is the second parameter of relaxation, and Ē is the equivalent elastic modulus, and Δε̅ₚₚ is the range of equivalent plastic strain caused by fatigue in one cycle, and σ̅ₘ is the equivalent average stress of one cycle, and n₂ is the index of steady creep, and σ_{H} is hydrostatic stress, and σ̅ represents equivalent stress.

Further, in the multiaxial creep-fatigue prediction method based on ABAQUS of the present invention, in S4, an ABAQUS finite element model under the multiaxial stress-strain state is established, and boundary conditions and external loads are applied, and the model mesh is divided, so as to get the stress-strain tensor for each cycle of each integration point.

Further, in the multiaxial creep-fatigue prediction method based on ABAQUS of the present invention, S5 further comprises:

S51: extracting the stress tensor and strain tensor of each node in the ABAQUS model by means of the user subroutine USDFLD;

S52: obtaining the equivalent stress and the equivalent plastic strain at each moment and the elastic following factor within the holding time of each cycle through scalar calculations, by means of the user subroutine USDFLD in combination with S51, to finally achieve the fatigue damage and creep damage of each cycle;

S53: calculating the total damage under the multiaxial creep-fatigue condition through the user subroutine USDFLD by using the following formula (11):

D⁽ⁿ⁾>Σᵢ₌₁ⁿd_{f}⁽ⁱ⁾+d_{c}^{(f)} (11);

In the formula, is the cumulative total damage of the preceding n cycles, dⱼ⁽ⁱ⁾ is the fatigue damage generated in the i-th cycle, d_{c}⁽ⁱ⁾ is the creep damage generated in the i-th cycle.

Wherein, when the total damage stack rate of a node first reaches the failure value 1, it can be defined as the most dangerous node and the crack initiation life nᵢ can be determined.

It should be noted that, the crack initiation life is characterized by cycle times nᵢ in the technical solution of the present invention.

The multiaxial creep-fatigue prediction method based on ABAQUS of the present invention has the following advantages and beneficial effects:

(1) The multiaxial creep-fatigue prediction method of the present invention defines the viscoplastic constitutive equation of the material to be tested by using the user-based subroutine UMAT, so as to obtain the creep-fatigue behavior under the multiaxial stress-strain state;

(2) The multiaxial creep-fatigue prediction method of the present invention calculates the equivalent stress and equivalent plastic strain by using the user-based subroutine USDFLD, so as to obtain the creep damage, the fatigue damage and the total damage values of each integration point in each cycle;

(3) The multiaxial creep-fatigue prediction method of the present invention has strong intuitiveness, and can intuitively obtain the crack initiation position of the geometric discontinuous structures and the crack initiation life of the position.

### BRIEF DESCRIPTION OF THE DRAWINGS

These and other features and advantages of this application will become more apparent to those skilled in the art from the detailed description of preferred embodiment. The drawings that accompany the description are described below.

FIG. 1 is a flow chart according to an embodiment of the multiaxial creep-fatigue prediction method based on ABAQUS of the present invention.

FIG. 2 schematically shows the fitting result of the uniaxial tensile test and the simulation curve according to an embodiment of the multiaxial creep-fatigue prediction method based on ABAQUS of the present invention.

FIG. 3 schematically shows the fitting result of the cyclic softening data of the uniaxial creep-fatigue test and the simulation curve according to an embodiment of the multiaxial creep-fatigue prediction method based on ABAQUS of the present invention.

FIG. 4 schematically shows the fitting result of the stress relaxation data of the uniaxial creep-fatigue test and the simulation curve according to an embodiment of the multiaxial creep-fatigue prediction method based on ABAQUS of the present invention.

FIG. 5 schematically shows the fitting result of the exponential equation for the static recovery term of the uniaxial creep-fatigue test according to an embodiment of the multiaxial creep-fatigue prediction method based on ABAQUS of the present invention.

FIG. 6 schematically shows the track of the fatigue damage per cycle and the creep damage per cycle following with the cycles of two potential danger points according to an embodiment of the multiaxial creep-fatigue prediction method based on ABAQUS of the present invention.

FIG. 7 schematically shows the hysteresis loop of the preceding 100 cycles of a certain potential danger point according to an embodiment of the multiaxial creep-fatigue prediction method based on ABAQUS of the present invention.

FIG. 8 schematically shows the hysteresis loop of the preceding 100 cycles of another potential danger point according to an embodiment of the multiaxial creep-fatigue prediction method based on ABAQUS of the present invention.

FIG. 9 schematically shows the creep-fatigue damage track and the crack initiation life prediction of the most dangerous integration point of the subsurface of the notch root according to an embodiment of the multiaxial creep-fatigue prediction method based on ABAQUS of the present invention.

FIG. 10 schematically shows the track of the fatigue damage per cycle and the creep damage per cycle following with the cycles of two potential danger points according to another embodiment of the multiaxial creep-fatigue prediction method based on ABAQUS of the present invention.

FIG. 11 schematically shows the hysteresis loop of the preceding 100 cycles of a certain potential danger point according to another embodiment of the multiaxial creep-fatigue prediction method based on ABAQUS of the present invention.

FIG. 12 schematically shows the hysteresis loop of the preceding 100 cycles of another potential danger point according to another embodiment of the multiaxial creep-fatigue prediction method based on ABAQUS of the present invention.

FIG. 13 schematically shows the creep-fatigue damage track and the crack initiation life prediction of the surface of the notch root according to another embodiment of the multiaxial creep-fatigue prediction method based on ABAQUS of the present invention.

### DESCRIPTION OF THE PREFERRED EMBODIMENTS

The followings are used to further illustrate the present application with specific embodiments. It should be understood that the following embodiments is only used to explain the present application but not to limit the scope of the present application.

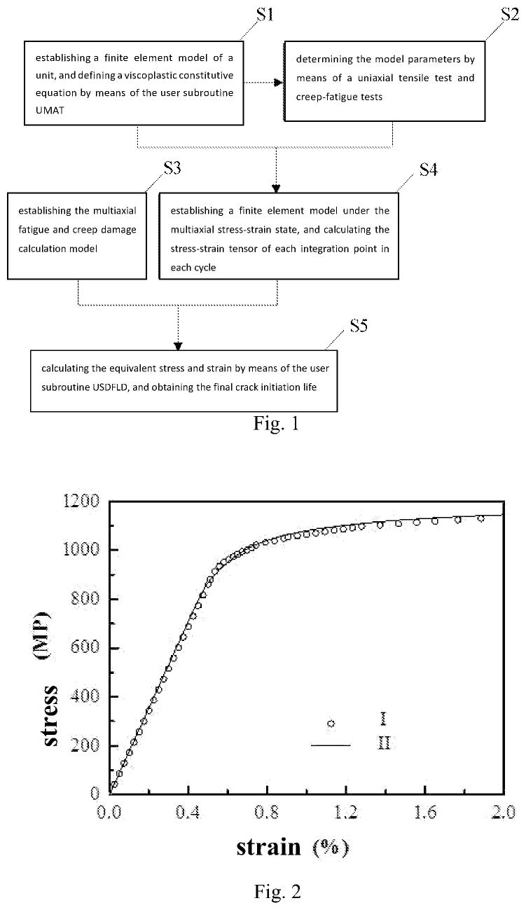

FIG. 1 is a flow chart according to an embodiment of the multiaxial creep-fatigue prediction method based on ABAQUS of the present invention.

As shown in FIG. 1, in this embodiment, the multiaxial creep-fatigue prediction method based on ABAQUS comprises steps:

S1: establishing an ABAQUS finite element model, and defining the viscoplastic constitutive equation of the material to be tested in the process of cycling loads by means of the user subroutine UMAT;

S2: determining the model parameters required by the viscoplastic constitutive equation;

S3: establishing the fatigue damage calculation model and creep damage calculation model of the multiaxial stress-strain state of the material to be tested;

S4: establishing an ABAQUS finite element model under the multiaxial stress-strain state, and calculating the stress-strain tensor of each cycle based on the viscoplastic constitutive equation defined by the user subroutine UMAT in S1 and the model parameters in S2;

S5: calculating the equivalent stress and equivalent plastic strain by means of the user subroutine USDFLD, and superimposing the fatigue damage and creep damage of each cycle according to the linear cumulative damage criterion to obtain the crack initiation life of the material to be tested based on the fatigue damage calculation model and creep damage calculation model in S3 in combination with the stress-strain tensor obtained in S4.

Wherein, in S2, the material to be tested is subjected to a uniaxial tensile test at a given temperature and uniaxial creep-fatigue tests with different strain amplitudes and loading time at the given temperature, such that the high-temperature tensile curve, the cyclic softening curve, the stress relaxation curve and the hysteresis loop are obtained to determine the model parameters required by the viscoplastic constitutive equation. In addition, the high-temperature tensile curve, the cyclic softening curve, the stress relaxation curve and the hysteresis loop of the ABAQUS finite element model are simulated by trial parameter method to obtain the model parameters required by the viscoplastic constitutive equation.

Wherein, in S1, the viscoplastic constitutive equation comprises: the master equation of the viscoplastic constitution, the viscoplastic equation of the viscoplastic constitution, the inelastic follow-up strengthening equation for the back stress tensor of the viscoplastic constitution and the isotropic strengthening equation of the viscoplastic constitution, which can be obtained by the following steps:

S11: describing the master equation of the viscoplastic constitution by using the following formula (1) and formula (2):

$$\begin{matrix}{ɛ}_{t} = {ɛ}_{e} + {ɛ}_{in} ; & ( 1 ) \\ {ɛ}_{e} = \frac{1 + v}{E} σ - \frac{v}{E} ( tr σ ) I ; & ( 2 )\end{matrix}$$

In the formulas, εₜ is the total strain tensor, and εₑ is the elastic strain tensor, and εᵢₙ is the inelastic strain tensor, and E is the elastic modulus, and ν is the Poisson's ratio, and σ is the stress tensor, and trσ is the track of the stress tensor, and I is the second-order unit tensor.

S12: describing the viscoplastic equation of the viscoplastic constitution by using the following formula (3), formula (4) and formula (5):

$$\begin{matrix}{\dot{ɛ}}_{in} = \frac{3}{2} \dot{p} \frac{s - a}{J ( σ - α )} ; & ( 3 ) \\ \dot{p} = \sqrt{\frac{2}{3} {\dot{ɛ}}_{in} \text{:} {\dot{ɛ}}_{in}} = {( \frac{J ( σ - α ) - R - κ}{K} )}^{n} ; & ( 4 ) \\ J ( σ - a ) = \sqrt{\frac{3}{2} ( s - a ) \text{:} ( s - a )} ; & ( 5 )\end{matrix}$$

In the formulas, \dot{ε}ᵢₙ is the inelastic strain rate tensor, and \dot{p} is the cumulative inelastic strain rate, and s is the deflection of the stress tensor, and a is the deflection of the back stress tensor, and J(σ−α) is the Von-Mises stress space distance, and α is the back stress tensor, and K and n are rate-related material parameters, and R is the isotropic deformation resistance, and κ is the initial size of the elastic region, and “:” represents the inner product of the tensor.

S13: describing the inelastic follow-up strengthening equation for the back stress tensor of the viscoplastic constitution by using the following formula (6) and formula (7):

αᵢ=ζᵢ(⅔rᵢ\dot{ε}ᵢₙ−αᵢ\dot{p})−γ[J(αᵢ)]^{m(q)}αᵢ (6);

m(q)=ϕ₁e^{-q/ω}+ϕ>₂ (7)

In the formulas, αᵢ represents each part of several back stress tensor parts, and ζᵢ and rᵢ are the material parameters of each part of the back stress tensor, and γ is the material parameter describing the static recovery term, and m(q) is the exponential equation describing the static recovery term, and q is the plastic strain amplitude, and ϕ₁, ϕ₂ and ω are the three material parameters in the exponential equation, and J(αᵢ) represents the second invariant of the back stress, and e represents the exponential function based on the natural constant, and \dot{α}ᵢ represents the stress change rate of each part of the back stress tensor.

S14: describing the isotropic strengthening equation of the viscoplastic constitution by using the following formula (8):

\dot{R}=b(Q−R)\dot{p}+H(1+bp)\dot{p} (8);

In the formula, Q is the asymptotic value of the isotropic resistance softening rapidly in the first stage, and b is the speed parameter close to the asymptotic value, and H is the slope-related parameter of linear softening in the second stage, and p is the cumulative inelastic strain, and R represents the isotropic enhancement rate.

It should be noted that the back stress tensor is divided into 8 parts in the above steps, namely, α=Σᵢ₌₁⁸αᵢ.

And in S3, the fatigue damage calculation model of the multiaxial stress-strain state is:

$${( \frac{{τ}_{max}}{{τ}_{f}^{′}} \frac{Δ γ}{2} + \frac{{σ}_{n , max}}{{σ}_{f}^{′}} \frac{{Δɛ}_{n}}{2} )}_{max} = \frac{{τ}_{f}^{′}}{G} {( \frac{2}{{d}_{f}} )}^{2 {b}_{0}} + {{γ}_{f}^{′} ( \frac{2}{{d}_{f}} )}^{2 {c}_{0}} ; \qquad ( 9 )$$

In the formula, “( )ₘₐₓ” represents the maximum fatigue damage factor on the critical plane, and τₘₐₓ is the maximum shear stress on the critical plane, and \dot{τ}_{f} is the constant of shear fatigue strength, and Δγ/2 is the shear strain amplitude on the critical plane, and σ_{n,max} is the maximum normal stress on the critical plane, and \dot{σ}_{f} is the constant of fatigue strength, and Δεₙ/2 is the normal strain amplitude on the critical plane, and G is the shear modulus, and d_{f} is the fatigue damage of one cycle, and b₀ is the index of fatigue strength, and [symbol] is the constant of shear fatigue ductility, and c₀ is the index of fatigue ductility.

The creep damage calculation model of the multiaxial stress-strain state is:

$$\{ \begin{matrix}{d}_{c} = {\int }_{0}^{{t}_{h}} \{ \frac{\frac{Z \cdot {M}_{1}}{Z + t} \frac{Z \cdot {N}_{1}}{Z + t} \cdot log ( 1 + \frac{t}{Z} )}{min [ {{φ}_{1} [ \frac{Z \cdot {M}_{1}}{Z + t} \frac{Z \cdot {N}_{1}}{Z + t} \cdot log ( 1 + \frac{t}{Z} ) ]}^{{n}_{1}} \cdot MDF , {w}_{f , trans} ]} - \\ \frac{\frac{Z \cdot {M}_{1}}{Z + t} \frac{Z \cdot {N}_{1}}{Z + t} \cdot log ( 1 + \frac{t}{Z} )}{{w}_{f , trans}} \} \\ {M}_{1} = \frac{{\overline{σ}}_{0} \cdot ( A log Δ {\overline{ɛ}}_{pp} + B )}{\overline{E} ln 10} \cdot log ( 1 + \frac{{\overline{σ}}_{m}}{{\overline{σ}}_{0}} ) \\ {N}_{1} = \frac{{( A log Δ {\overline{ɛ}}_{pp} + B )}^{2}}{\overline{E} ln 10} \\ MDF = exp [ \frac{2}{3} ( \frac{{n}_{2} - 0.5}{{n}_{2} + 0.5} ) ] / exp [ 2 ( \frac{{n}_{2} - 0.5}{{n}_{2} + 0.5} ) \frac{{σ}_{H}}{\overline{σ}} ] ;\end{matrix} \qquad ( 10 )$$

In the formula, d_{c} is the creep damage of one cycle, and tₕ is the holding time of one cycle, and Z is the elastic following factor, and t represents the time from the start of loading in one cycle, and φ₁ is the first linear regression parameter of creep damage, and MDF is the multiaxial ductility factor, and n₁ is the second linear regression parameter of creep damage, and w_{f,trans} is the plateau value of the failure strain energy density, and σ̅₀ is the maximum equivalent stress before loading in one cycle, and A is the first parameter of relaxation, and B is the second parameter of relaxation, and Ē is the equivalent elastic modulus, and Δε̅ₚₚ is the range of equivalent plastic strain caused by fatigue in one cycle, and σₘ is the equivalent average stress of one cycle, and n₂ is the index of steady creep, and σ_{H} is hydrostatic stress, and σ̅ represents equivalent stress.

While in S4, an ABAQUS finite element model under the multiaxial stress-strain state is established, and boundary conditions and external loads are applied, and the model mesh is divided, so as to get the stress-strain tensor for each cycle of each integration point.

In this embodiment, S5 can further comprise:

S51: extracting the stress tensor and strain tensor of each node in the ABAQUS model by means of the user subroutine USDFLD;

S52: obtaining the equivalent stress and the equivalent plastic strain at each moment and the elastic following factor within the holding time of each cycle through scalar calculations, by means of the user subroutine USDFLD in combination with S51, to finally achieve the fatigue damage and creep damage of each cycle;

S53: calculating the total damage under the multiaxial creep-fatigue condition through the user subroutine USDFLD by using the following formula (11):

D⁽ⁿ⁾=Σᵢ₌₁ⁿd_{f}⁽ⁱ⁾+d_{c}⁽ⁱ⁾ (11);

In the formula, D⁽ⁿ⁾ is the cumulative total damage of the preceding n cycles, d_{f}⁽ⁱ⁾ is the fatigue damage generated in the i-th cycle, d_{c}⁽ⁱ⁾ is the creep damage generated in the i-th cycle.

Wherein, when the total damage stack rate of a node first reaches the failure value 1, it can be defined as the most dangerous node and the crack initiation life nᵢ can be determined.

In order to better illustrate the prediction effect of the multiaxial creep-fatigue prediction method based on ABAQUS of the present invention, a unilateral notched specimen with a notch radius of 8 mm will be used for verification.

The material of the unilateral notched specimen used in the verification is the super alloy GH4169 with high-temperature nickel base, and the creep-fatigue test is carried out in an air environment of 650° C. During the test, the sum of external loads applied at both ends of the specimen is the overall strain control. The weakest part of the notch root is in a state of multiaxial stress-strain due to the geometric discontinuity of the unilateral notched specimen. Prior to this, a uniaxial tensile test in an air environment of 650° C. and uniaxial creep-fatigue tests with different strain amplitudes and holding time under this environment are required. The obtained test results are used to determine the material parameters required by the viscoplastic constitutive equations of formulas (1) to (8).

The simulation result of the uniaxial tensile test is adjusted by trial parameter method, so that it can be in good agreement with the uniaxial tensile test. FIG. 2 schematically shows the fitting result of the uniaxial tensile test and the simulation curve according to an embodiment of the multiaxial creep-fatigue prediction method based on ABAQUS of the present invention.

As shown in FIG. 2, I represents the uniaxial tensile test data, and II represents the uniaxial tensile test curve obtained by the trial parameter method. The simulation result of the uniaxial tensile test curve II is adjusted by the trial parameter method to make it in good agreement with the uniaxial tensile test data obtained from the uniaxial creep-fatigue test. Wherein, the elastic modulus E=177 GPa, Poisson's ratio ν=0.33, the initial size of the elastic region K=815 MPa, the parameters of the follow-up strengthening material for each part of each back stress tensor: ζ₁=6130, ζ₂=1807, ζ₃=892, ζ₄=352, ζ₅=150, ζ₆=88.2, ζ₇=75.0, ζ₈=28.4, r₁=23.4, r₂=68.0, r₃=75.9, r₄=48.0, r₅=43.4, r₆=25.4, r₇=54.5, r₈=28.0, rate-related viscoplastic material parameters: K=400, n=2.0.

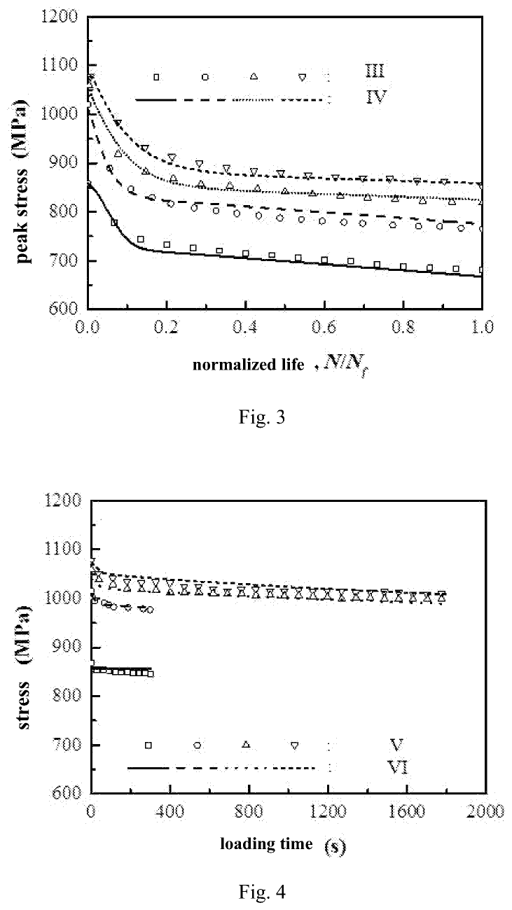

FIG. 3 schematically shows the fitting result of the cyclic softening data of the uniaxial creep-fatigue test and the simulation curve according to an embodiment of the multiaxial creep-fatigue prediction method based on ABAQUS of the present invention.

As shown in FIG. 3, III represents the cyclic softening test data, and IV represents the cyclic softening curve obtained by using the trial parameter method. The simulation result of the cyclic softening curve IV is adjusted by the trial parameter method to make it in good agreement with the cyclic softening data obtained from the uniaxial creep-fatigue tests. Wherein, the isotropic strengthening material parameters: the parameter related to the slope of the linear softening in the second stage H=−8.5, the speed parameter close to the asymptotic value b=4.1,the asymptotic value of the isotropic resistance softening rapidly in the first stage Q=618 MPa.

FIG. 4 schematically shows the fitting result of the stress relaxation data of the uniaxial creep-fatigue test and the simulation curve according to an embodiment of the multiaxial creep-fatigue prediction method based on ABAQUS of the present invention.

As shown in FIG. 4, V represents the stress relaxation data of the uniaxial creep-fatigue test, VI represents the stress relaxation curve obtained by the trial parameter method. The simulation result of the stress relaxation curve of the first cycle is adjusted by the trial parameter method, making it in good agreement with the stress relaxation data obtained from the uniaxial creep-fatigue test. Wherein, the independent material parameter in the static recovery term: γ=4.0×10⁻⁷.

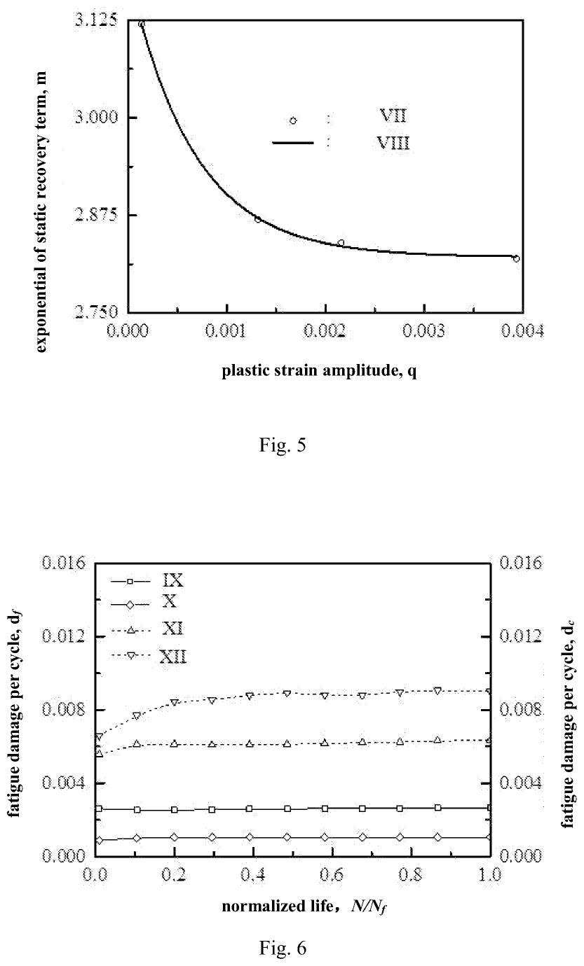

At the same time, the exponential equation of the static recovery term in formula (7) is fitted, and the fitting result is shown in FIG. 5. FIG. 5 schematically shows the fitting result of the exponential equation for the static recovery term of the uniaxial creep-fatigue test according to an embodiment of the multiaxial creep-fatigue prediction method based on ABAQUS of the present invention.

As shown in FIG. 5, VII represents the uniaxial creep-fatigue test data, and VIII represents the simulation result curve. Wherein, the material parameters of the exponential equation in the static recovery term: φ₁=0.37, φ₂=2.82, ω=6.6×10⁻⁴.

In an embodiment of the present invention, the selected data is: the total strain range of is 1.0%, the holding time at the maximum strain in each cycle is 3600 s, and the unilateral notched creep-fatigue test is in an air environment of 650° C. The creep-fatigue cracks originate on the subsurface of the notch root, and the crack initiation life is 76 cycles.

FIG. 6 shows the track of the fatigue damage and the creep damage per cycle at two typical positons in this embodiment.

As shown in FIG. 6, curve IX represents the fatigue damage curve per cycle of the surface of the notch root, curve X represents the fatigue damage curve per cycle of the subsurface of the notch root, curve XI represents the creep damage curve per cycle of the surface of the notch root, and curve XII represents the creep damage curve per cycle of the subsurface of the notch root. Wherein, the integration points of the surface of the notch root are selected, which are affected by the stress concentration during the process of cycling the loads, leading the fatigue cracks usually to originate on the surface, so the integration points of the surface of the notch root are usually considered as the potential dangerous points in the fatigue process. The integration points of the subsurface of the notch root are selected, because the subsurface usually has a higher stress triaxiality than the surface and the creep cracks usually originate inside, and the integration points of the subsurface of the notch root are usually considered as the potential dangerous points in the creep process. It can be seen from FIG. 6 that due to the longer holding time in this embodiment, the creep damage dominates during the process of cycling the loads, so the position to calculate the maximum total damage is on the subsurface of the notch root, which is the same as the experimental observation.

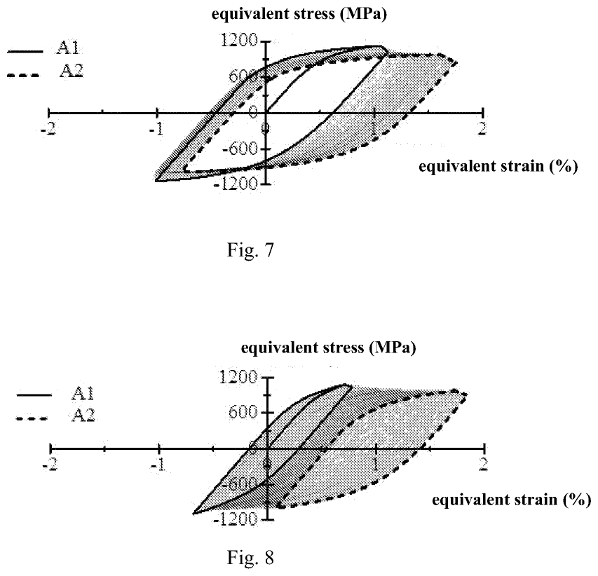

FIG. 7 and FIG. 8 show the hysteresis loops of the preceding 100 cycles of two positions at the surface and subsurface of the notch root shown in FIG. 6. Wherein, FIG. 7 shows the hysteresis loop at the integration points of the surface of the notch root, FIG. 8 shows the hysteresis loop at the integration points of the subsurface of the notch root. In FIG. 7 and FIG. 8, A1 represents the first cycle, and A2 represents the 100-th cycle.

It can be seen from FIG. 7 and FIG. 8 that the integration points of the subsurface have a more obvious accumulation of inelastic strain, although the integration points of the surface of the notch root have a larger inelastic strain range. This is due to the influence of multiaxial stress-strain state, the geometric discontinuity is in the stress-strain mixed control mode in the loading stage. It can also be seen from FIG. 7 and FIG. 8 that the integration points of the subsurface are closer to the stress control mode, resulting in more obvious creep damage, which explains that the crack initiation position of the cyclic loads dominated by creep appears on the subsurface of the notch root.

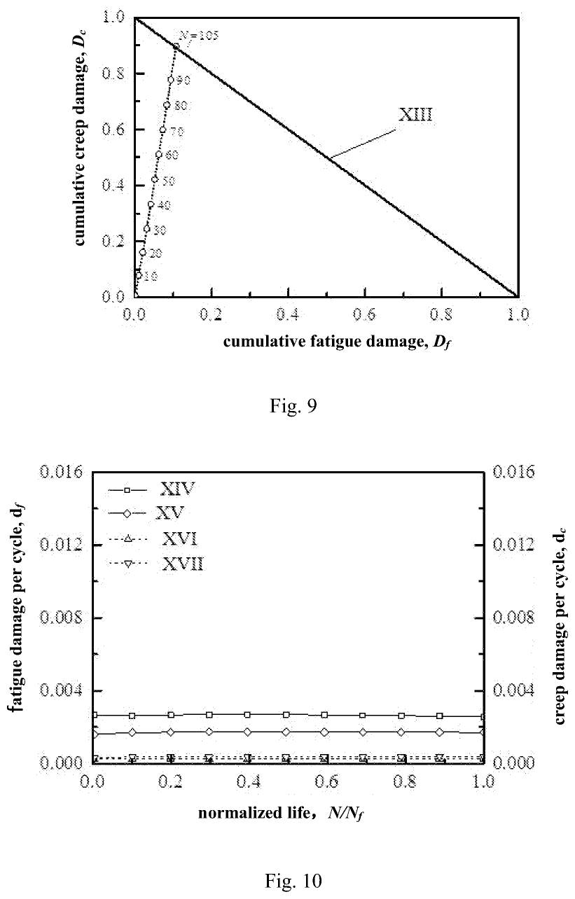

FIG. 9 schematically shows the creep-fatigue damage track and the crack initiation life prediction of the most dangerous integration point of the subsurface of the notch root according to an embodiment of the multiaxial creep-fatigue prediction method based on ABAQUS of the present invention.

With the aid of the creep-fatigue damage interactive map, the most dangerous integration points of the subsurface near the notch root can be traced. As shown in FIG. 9, it can be known that the crack initiation life of this embodiment is 105 cycles, which is relatively close to the results of 76 cycles obtained by the experiment, and the numerical simulation method is proved to be highly reliable within the range of 1.5 times the error band.

It should be noted that the curve XIII in FIG. 9 represents Σᵢ₌₁ⁿd_{f}⁽ⁱ⁾+d_{c}⁽ⁱ⁾=1.

In another embodiment of the present invention, the selected data is: the total strain range of is 1.0%, the holding time at the maximum strain in each cycle is 60 s, and the unilateral notched creep-fatigue test is in an air environment of 650° C. The creep-fatigue cracks originate on the surface of the notch root, and the crack initiation life is 480 cycles.

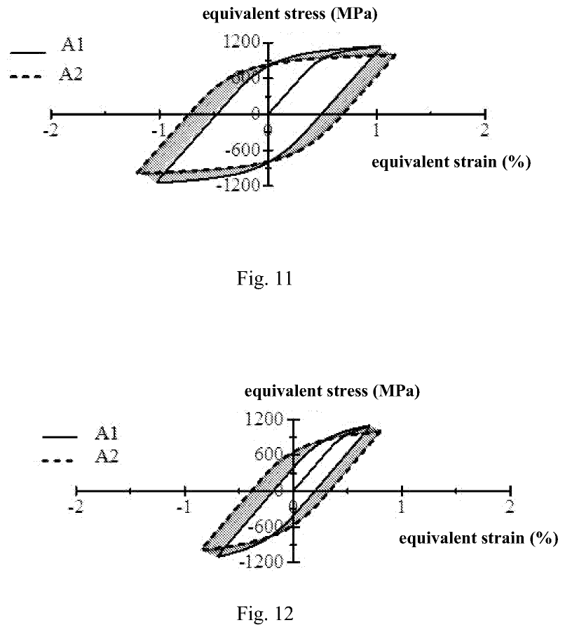

FIG. 10 shows the track of the fatigue damage and the creep damage per cycle at two typical positons in this embodiment.

As shown in FIG. 10 curve XIV represents the fatigue damage curve per cycle of the surface of the notch root, curve XV represents the fatigue damage curve per cycle of the subsurface of the notch root, curve XVI represents the creep damage curve per cycle of the surface of the notch root, and curve XVII represents the creep damage curve per cycle of the subsurface of the notch root. Wherein, the integration points of the surface of the notch root are selected, which are affected by the stress concentration during the process of cycling the loads, leading the fatigue cracks usually to originate on the surface, so the integration points of the surface of the notch root are usually considered as the potential dangerous points in the fatigue process. The integration points of the subsurface of the notch root are selected, because the subsurface usually has a higher stress triaxiality than the surface and the creep cracks usually originate inside, so the integration points of the subsurface of the notch root are usually considered as the potential dangerous points in the creep process. It can be seen from FIG. 10 that due to the shorter holding time in this embodiment, the fatigue damage dominates during the process of cycling the loads, so the position to calculate the maximum total damage is on the surface of the notch root, which is the same as the experimental observation.

FIG. 11 and FIG. 12 show the hysteresis loops of the preceding 100 cycles of two positions at the surface and subsurface of the notch root shown in FIG. 10. Wherein, FIG. 11 shows the hysteresis loop at the integration points of the surface of the notch root, FIG. 12 shows the hysteresis loop at the integration points of the subsurface of the notch root. In FIG. 11 and FIG. 12, A1 represents the first cycle, and A2 represents the 100-th cycle.

It can be seen from FIG. 11 and FIG. 12 that the integration points of the surface of the notch root have a larger inelastic strain range, and the integration points at the surface and the subsurface of the notch root have almost no accumulation of inelastic strain. It can be seen from FIG. 11 and FIG. 12 that the creep/relaxation phenomenon caused by the short holding time in this embodiment is almost negligible. In this case, the fatigue damage caused by the inelastic strain range makes the crack initiation position appear on the surface of the notch root.

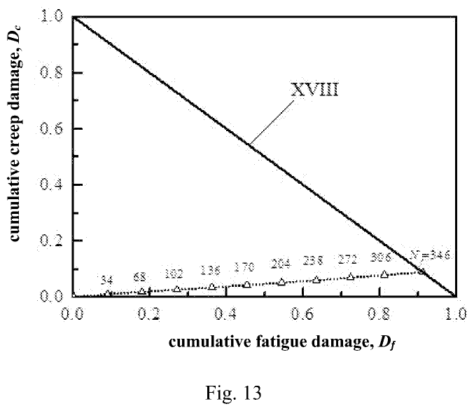

FIG. 13 schematically shows the creep-fatigue damage track and the crack initiation life prediction of the surface of the notch root according to another embodiment of the multiaxial creep-fatigue prediction method based on ABAQUS of the present invention.

With the aid of the creep-fatigue damage interactive map, the most dangerous integration points of the subsurface near the notch root can be traced. As shown in FIG. 13, it can be known that the crack initiation life of this embodiment is 346 cycles, which is relatively close to the results of 480 cycles obtained by the experiment, and the numerical simulation method is proved to be highly reliable within the range of 1.5 times the error band.

It should be noted that the curve XVIII in FIG. 13 represents Σᵢ₌₁ⁿd_{f}⁽ⁱ⁾+d_{c}⁽ⁱ⁾=1.

In summary, it can be seen that the multiaxial creep-fatigue prediction method of the present invention defines the viscoplastic constitutive equation of the material to be tested by using the user-based subroutine UMAT, so as to obtain the creep-fatigue behavior under the multiaxial stress-strain state.

In addition, the multiaxial creep-fatigue prediction method of the present invention calculates the equivalent stress and equivalent plastic strain by using the user-based subroutine USDFLD, so as to obtain the creep damage, the fatigue damage and the total damage values of each integration point in each cycle.

Moreover, the multiaxial creep-fatigue prediction method of the present invention has strong intuitiveness, and can intuitively obtain the crack initiation position of the geometric discontinuous structures and the crack initiation life of the position.

It should be noted that the part of prior art in the protection scope of the present invention is not limited to the embodiments given in this application document, and all prior art that is not inconsistent with the solution of the present invention, including but is not limited to the prior patent documents, prior publications, prior public use, etc., can all be incorporated in the protection scope of the present invention.

In addition, the combination of various technical features in this application is not limited to the combination described in the claims or described in the specific embodiments. All technical features described in this application can be freely combined or incorporated in any way, unless contradictions arise between each other.

It should also be noted that the above-listed embodiments are only specific embodiments of the present invention. Obviously, the present invention is not limited to the above embodiments, and the subsequent similar changes or modifications can be directly derived from or easily associated with the disclosure of the present invention by those skilled in the art, and should fall within the protection scope of the present invention.

1. A multiaxial creep-fatigue prediction method based on ABAQUS comprising the steps of:
S1: establishing an ABAQUS finite element model, and defining viscoplastic constitutive equation of a material to be tested in process of cycling loads by means of a user subroutine UMAT;
S2: determining model parameters required by the viscoplastic constitutive equation;
S3: establishing fatigue damage calculation model and creep damage calculation model of multiaxial stress-strain state of the material to be tested;
S4: establishing an ABAQUS finite element model under the multiaxial stress-strain state, and calculating stress-strain tensor of each cycle based on the viscoplastic constitutive equation defined by the user subroutine UMAT in S1 and the model parameters in S2; and
S5: calculating equivalent stress and equivalent plastic strain by means of a user subroutine USDFLD, and superimposing fatigue damage and creep damage of each cycle according to linear cumulative damage criterion to obtain crack initiation life of the material to be tested based on the fatigue damage calculation model and creep damage calculation model in S3 in combination with the stress-strain tensor obtained in S4.

2. The multiaxial creep-fatigue prediction method based on ABAQUS according to claim 1, wherein in S2, the material to be tested is subjected to a uniaxial tensile test at a given temperature and uniaxial creep-fatigue tests with different strain amplitudes and holding time at the given temperature, such that a high-temperature tensile curve, a cyclic softening curve, a stress relaxation curve and a hysteresis loop are obtained to determine the model parameters required by the viscoplastic constitutive equation.

3. The multiaxial creep-fatigue prediction method based on ABAQUS according to claim 2, wherein in S2, the high-temperature tensile curve, the cyclic softening curve, the stress relaxation curve and the hysteresis loop of the ABAQUS finite element model are simulated by trial parameter method.

4. The multiaxial creep-fatigue prediction method based on ABAQUS according to claim 1, wherein in S1, the viscoplastic constitutive equation comprises: master equation of the viscoplastic constitution, viscoplastic equation of the viscoplastic constitution, inelastic follow-up strengthening equation for back stress tensor of the viscoplastic constitution and isotropic strengthening equation of the viscoplastic constitution.

5. The multiaxial creep-fatigue prediction method based on ABAQUS according to claim 4, wherein, S1 further comprises the steps of:
S11: describing the master equation of the viscoplastic constitution by using following formula (1) and formula (2):
$$\begin{matrix}{ɛ}_{t} = {ɛ}_{e} + {ɛ}_{in} ; & ( 1 ) \\ {ɛ}_{e} = \frac{1 + v}{E} σ - \frac{v}{E} ( tr σ ) I ; & ( 2 )\end{matrix}$$
wherein, εₜ is total strain tensor, and Ee is elastic strain tensor, and εᵢₙ is inelastic strain tensor, and E is elastic modulus, and ν is Poisson's ratio, and σ is stress tensor, and trσ is track of stress tensor, and I is second-order unit tensor;
S12: describing the viscoplastic equation of the viscoplastic constitution by using following formula (3), formula (4) and formula (5):
$$\begin{matrix}{\dot{ɛ}}_{in} = \frac{3}{2} \dot{p} \frac{s - a}{J ( σ - α )} ; & ( 3 ) \\ \dot{p} = \sqrt{\frac{2}{3} {\dot{ɛ}}_{in} \text{:} {\dot{ɛ}}_{in}} = {( \frac{J ( σ - α ) - R - κ}{K} )}^{n} ; & ( 4 ) \\ J ( σ - a ) = \sqrt{\frac{3}{2} ( s - a ) \text{:} ( s - a )} ; & ( 5 )\end{matrix}$$
wherein, \dot{ε}ᵢₙ is inelastic strain rate tensor, and \dot{p} is cumulative inelastic strain rate, and s is deflection of the stress tensor, and a is deflection of the back stress tensor, and J(σ−α) is Von-Mises stress space distance, and α is the back stress tensor, and K and n are rate-related material parameters, and R is isotropic deformation resistance, and K is the initial size of the elastic region, and “:” represents inner product of tensor;
S13: describing the inelastic follow-up strengthening equation for the back stress tensor of the viscoplastic constitution by using following formula (6) and formula (7):
\dot{α}ᵢ=ζ(⅔rᵢ\dot{ε}ᵢₙ−αᵢ\dot{p})−γ[J(αᵢ)]^{m(q)}αᵢ (6);
m(q)=ϕ₁e^{-w/ω}+ϕ₂ (7)
wherein, αᵢ represents each part of several back stress tensor parts, and ζᵢ and rᵢ are material parameters of each part of the back stress tensor, and γ is material parameter describing static recovery term, and m(q) is exponential equation describing the static recovery term, and q is plastic strain amplitude, and ϕ₁, ϕ₂ and w are three material parameters in the exponential equation, and J(αᵢ) represents second invariant of the back stress, and e represents exponential function based on natural constant, and \dot{α}ᵢ represents stress change rate of each part of the back stress tensor; and
S14: describing the isotropic strengthening equation of the viscoplastic constitution by using following formula (8):
\dot{R}=b(Q−R)\dot{p}+H(1+bp)\dot{p} (8);
wherein, Q is an asymptotic value of isotropic resistance softening rapidly in first stage, and b is a speed parameter close to the asymptotic value, and H is a slope-related parameter of linear softening in second stage, and p is cumulative inelastic strain, and \dot{R} represents isotropic enhancement rate.

6. The multiaxial creep-fatigue prediction method based on ABAQUS according to claim 5, wherein the back stress tensor is divided into 8 parts, namely, α=Σᵢ₌₁⁸αᵢ.

7. The multiaxial creep-fatigue prediction method based on ABAQUS according to claim 1, wherein in S3, the fatigue damage calculation model of the multiaxial stress-strain state is:
$${( \frac{{τ}_{max}}{{τ}_{f}^{′}} \frac{Δ γ}{2} + \frac{{σ}_{n , max}}{{σ}_{f}^{′}} \frac{{Δɛ}_{n}}{2} )}_{max} = \frac{{τ}_{f}^{′}}{G} {( \frac{2}{{d}_{f}} )}^{2 {b}_{0}} + {{γ}_{f}^{′} ( \frac{2}{{d}_{f}} )}^{2 {c}_{0}} ; \qquad ( 9 )$$
wherein, “( )ₘₐₓ” represents maximum fatigue damage factor on a critical plane, and τₘₐₓ is maximum shear stress on the critical plane, and τ_{f}′ is a constant of shear fatigue strength, and Δγ/2 is shear strain amplitude on the critical plane, and σ_{n,max} is maximum normal stress on the critical plane, and σ_{f}′ is a constant of fatigue strength, and Δεₙ/2 is normal strain amplitude on the critical plane, and G is shear modulus, and d_{f} is fatigue damage of one cycle, and b₀ is an index of fatigue strength, and γ_{f}′ is a constant of shear fatigue ductility, and c₀ is an index of fatigue ductility;
wherein the creep damage calculation model of the multiaxial stress-strain state is:
$$\{ \begin{matrix}{d}_{c} = {\int }_{0}^{{t}_{h}} \{ \frac{\frac{Z \cdot {M}_{1}}{Z + t} \frac{Z \cdot {N}_{1}}{Z + t} \cdot log ( 1 + \frac{t}{Z} )}{min [ {{φ}_{1} [ \frac{Z \cdot {M}_{1}}{Z + t} \frac{Z \cdot {N}_{1}}{Z + t} \cdot log ( 1 + \frac{t}{Z} ) ]}^{{n}_{1}} \cdot MDF , {w}_{f , trans} ]} - \\ \frac{\frac{Z \cdot {M}_{1}}{Z + t} \frac{Z \cdot {N}_{1}}{Z + t} \cdot log ( 1 + \frac{t}{Z} )}{{w}_{f , trans}} \} \\ {M}_{1} = \frac{{\overline{σ}}_{0} \cdot ( A log Δ {\overline{ɛ}}_{pp} + B )}{\overline{E} ln 10} \cdot log ( 1 + \frac{{\overline{σ}}_{m}}{{\overline{σ}}_{0}} ) \\ {N}_{1} = \frac{{( A log Δ {\overline{ɛ}}_{pp} + B )}^{2}}{\overline{E} ln 10} \\ MDF = exp [ \frac{2}{3} ( \frac{{n}_{2} - 0.5}{{n}_{2} + 0.5} ) ] / exp [ 2 ( \frac{{n}_{2} - 0.5}{{n}_{2} + 0.5} ) \frac{{σ}_{H}}{\overline{σ}} ] ;\end{matrix} \qquad ( 10 )$$
and
wherein, d_{c} is creep damage of one cycle, and tₕ is holding time of one cycle, and Z is elastic following factor, and t represents time from start of loading in one cycle, and φ₁ is a first linear regression parameter of creep damage, and MDF is a multiaxial ductility factor, and n₁ is a second linear regression parameter of creep damage, and w_{f,trans} is a plateau value of failure strain energy density, and σ̅₀ is maximum equivalent stress before loading in one cycle, and A is a first parameter of relaxation, and B is a second parameter of relaxation, and Ē is equivalent elastic modulus, and Δε̅ₚₚ is range of equivalent plastic strain caused by fatigue in one cycle, and σ̅ₘ is equivalent average stress of one cycle, and n₂ is an index of steady creep, and σ_{H} is hydrostatic stress, and U represents equivalent stress.

8. The multiaxial creep-fatigue prediction method based on ABAQUS according to claim 1, wherein in S4, an ABAQUS finite element model under the multiaxial stress-strain state is established, and boundary conditions and external loads are applied, and model mesh is divided, so as to get stress-strain tensor for each cycle of each integration point.

9. The multiaxial creep-fatigue prediction method based on ABAQUS according to claim 1, wherein, S5 further comprises steps:
S51: extracting stress tensor and strain tensor of each node in the ABAQUS model by means of the user subroutine USDFLD;
S52: obtaining equivalent stress and equivalent plastic strain at each moment and elastic following factor within holding time of each cycle through scalar calculations, by means of the user subroutine USDFLD in combination with S51, to finally achieve fatigue damage and creep damage of each cycle; and
S53: calculating total damage under multiaxial creep-fatigue condition through the user subroutine USDFLD by using following formula (11):
D⁽ⁿ⁾=Σᵢ₌₁ⁿd_{f}⁽ⁱ⁾+d_{c}⁽ⁱ⁾ (11);
wherein, D⁽ⁿ⁾ is cumulative total damage of preceding n cycles, d_{f}⁽ⁱ⁾ is fatigue damage generated in i-th cycle, d_{c}⁽ⁱ⁾ is creep damage generated in the i-th cycle; and
wherein, when total damage stack rate of a node first reaches failure value 1, it can be defined as a most dangerous node and crack initiation life nᵢ can be determined.
